(19) United States
(12) Patent Application Publication
(10) Pub. No.: US 2006/0218046 A1
(43) Pub. Date: Sep. 28, 2006

(54) Method and system of allocating a sales representative

(75) Inventors: Christopher Carfi, Half Moon Bay, CA (US); Leif Chastaine, Meridian, ID (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Cerado, Inc.

(21) Appl. No.: 11/086,512

(22) Filed: Mar. 22, 2005

(51) Int. Cl. G06Q 30/00

(52) U.S. Cl. 705/26

(57) ABSTRACT

A method and system is disclosed for providing for customer input during sales representative allocation by a vendor. According to the embodiments, a customer can participate in the allocation through a representative search function, a representative match function, and a contact find function, for instance. The system is generally employed on a server that handles database and processing operations. The system may also provide for searching and navigating via an internet connection through available sales representatives based on one or more traits of the sales representative.

### BACKGROUND

1. Field of the Invention

The present invention relates to the allocation of sales representatives and more particularly to the use of customer specific information in the allocation process.

2. Description of the Prior Art

Many vendors employ sales representatives (“representatives”) to interact with customers, carry out transactions and serve as intermediaries between the vendors and customers. The relationship between the sales representative and customer is often long-term, and the quality of the relationship can greatly alter sales, customer satisfaction, and customer retention.

A vendor typically assigns a customer to a sales representative. The assignment may be based on geography or other arbitrary factors, for instance. The customer, however, does not have any explicit mechanism for participating in the process selecting the sales representative.

### SUMMARY

Presently disclosed is a method and system for considering customer traits and input during a process of allocating sales representatives. According to the embodiments, a customer can explore the available sales representatives by searching for a sales representative based on one or more traits of the sales representative; receive a customer sales representative matching or ranking based in part on information provided by the customer; or via other methods.

The system is generally employed on a computer and/or network such as the Internet. For instance, a customer may navigate and view available sales representatives through a web-based interface such as an HTTP-type browser. The system may provide for searching and navigating through available sales representatives based on one or more traits of the sales representative. These traits may vary according to various factors such as vendor industry. However, some examples of sales representative traits include hometown, university, area of expertise, hobbies, experience. Other traits are certainly available.

The system may further provide access to an existing address book of the customer. By using the address book, the system can assist the customer in determining whether the customer has an existing relationship with any individuals at the vendor company. The list of existing relationships may be used as an additional basis for selecting the customer representative. Further, second degree relationships (friend of a friend; 1-degree of separation) may be used for the selection. The second degree relationships may be obtained through a data connection with social networking system for instance.

A matching function can compare a customer's profile with available sales representatives for the vendor. A match score may be generated for each customer-representative match. Additionally or alternatively, a list of representatives can be displayed in order of similarity, for instance.

Although a number of algorithms are available for providing matching functionality, an embodiment provides for a salesperson affinity matching system. The salesperson affinity matching system is configured to assist in matching a customer with one of a plurality of available sales representatives. The system may operate according to the following flow:

1. Receive a set of customer traits of the customer. These customer traits may include, for example, the customer's current geographic location, hometown, educational background, employment history, and other information, for instance.

2. Receive a set of representative traits of each representative of the plurality of available sales representatives. These representative traits may include, for example, the representative's current geographic location, hometown, educational background, employment history, and other information, for instance.

3. Create a matching data structure for storing and/or sorting/ordering customer and representative trait matches. The data structure may be implemented in a variety of ways, such as in a computer memory, as a database table, or as a spreadsheet, for instance.

4. Compare the set of customer traits with the set of representative traits, and populate the matching data structure with matching pairs of customer-representative traits. Thus, an entry in the data structure may reflect that the customer's geographic location matches that of a particular representative. Perform the comparison between each customer trait and each trait of each of the plurality of representatives.

5. Form an aggregate count that reflects the number of times each representative appears in the populated data structure.

6. Sort the list according to the aggregate count. Preferably, matching pairs of customer-representative traits that include representatives with a high aggregate count will appear marginally toward the top of the list.

7. Present information about the matched representatives to the user in descending order of aggregate count. Additionally, a graphical representation of the number of matches may be shown for each representative. This graphical representation may take the form of a bar with varying length, a number of stars, or other form. Further, the system may present a suggested match or set of best matches.

Other algorithms for matching vendor representatives with a customer are also available. For example, weighted matching that allows for different weights to be assigned according to the trait matched or quality of match, fuzzy matching, and/or industry specific matching may be used.

Once a representative is selected by the customer, the representative may be added to the customer's network or list of contacts associated with the vendor organization. In a further embodiment, the customer may add any number of individuals associated with the vendor organization to the customer's network. Thus, the customer may choose a sales representative from a given vendor and additionally maintain a network of contacts that are also associated with the vendor. Beneficially, allowing multiple contact points to the vendor creates a stronger bond between the customer and vendor.

Further, the selected representative may be notified through an e-mail, page, or other means.

### BRIEF DESCRIPTION OF THE DRAWINGS

FIG. 1 is a block diagram showing an exemplary system architecture.

FIG. 2 is a messaging diagram showing operation of an embodiment.

FIG. 3 is a flow chart showing a login procedure.

FIG. 4 is a flow chart showing a customer initiation.

FIG. 5 is a flow chart showing a representative search.

FIG. 6 is a flow chart showing a representative match.

FIG. 7 is a flow chart showing a contact search.

FIG. 8 is a flow chart showing a sales representative initiation

### DETAILED DESCRIPTION

1. Overview

The invention relates to the functions and operation of a system for providing customer input during the process of allocating a vendor's sales representative to a customer. The system may either operate over a distributed network, such as the Internet, or through other media, such as through oral or written communication.

The various embodiments described provide for various types of customer input. For instance, on one axis, the customer input may range from total control to minimal input. On another axis, the customer input may range from direct input to indirect input. In some cases, the customer may not even be consciously aware of providing input.

In a scenario, a customer can explore traits of a plurality of sales representatives by searching for a sales representative based on one of more desired traits. The customer may select a sales representative from the plurality of sales representatives based on the results of the search. Further, the system may provide a ranking of sales representatives based on the search results.

In another scenario, a server or other computer system creates a customer-representative match or rank based on information provided by the customer and information available regarding the representative. Once a suggested customer-representative match is determined, the system may provide a recommendation to the customer, to the representative, or to both. Further, the customer may add the representative to the customer's network and begin to communicate with the representative.

A matching algorithm for creating the customer-representative match may use empirical data concerning customer-representative relationship strengths based on traits of the customer and representative. For instance, research has shown that customer-representative trait similarity results in both increased sales and better relationships. The empirical results may vary according to the field of business. For instance, the traits that are important to an office manager/computer sales representative match may be different than those that are important to a medical doctor/pharmaceutical sales representative match, for instance.

In another algorithm, traits of members of the customer's network or contact list are used to determine a best match. For instance, a social networking software such as Orkut may provide to the system traits of members of the customer's Orkut network. By using these traits, a better match may be created—one theory behind this match type is that a customer may match better with representatives who are, in some way, similar to friends or other individuals within the customer's existing network.

2. Exemplary System Architecture

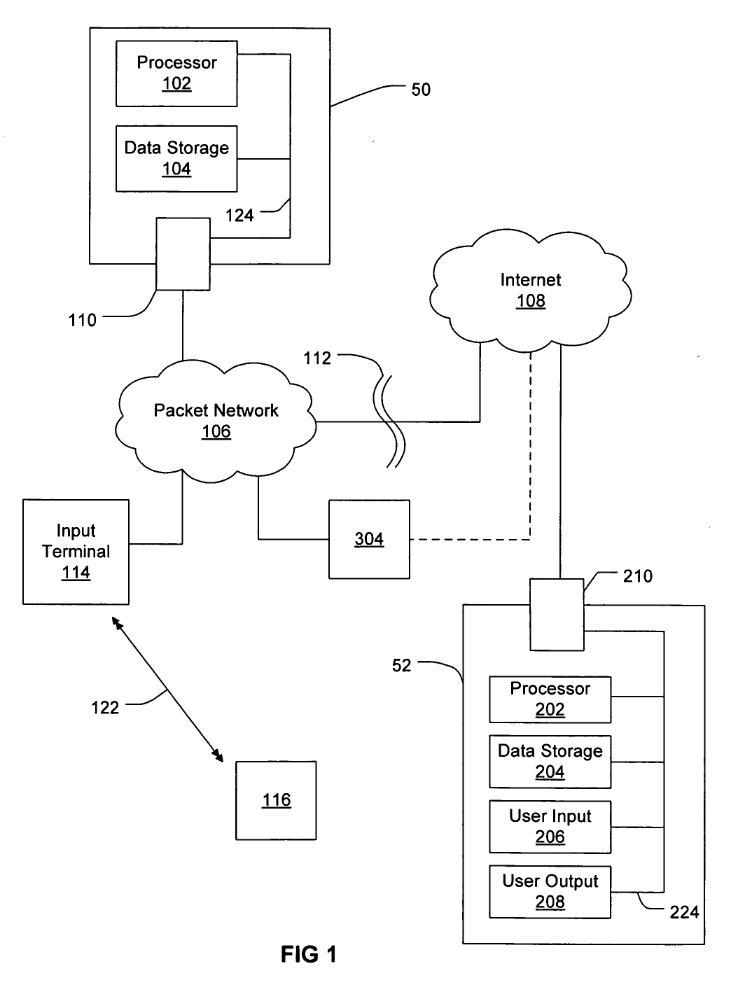

Referring now to the figures, FIG. 1 is a block diagram showing an architecture for carrying out an exemplary embodiment. A server 50 may be interconnected with a private packet network 106 such as a local area network (LAN). The server 50 includes a first processor 102 for executing machine language instructions stored at a first data storage 104. In addition to storing a set of computer readable instructions, such as computer software, the first data storage 104 may also include a database comprising (i) vendor data; (ii) customer data; and (iii) match data. A data port 110, such as an Ethernet port provides an interface for packet-based communication between the private packet network 106 and the server 50. The hardware elements of the server 50 are coupled together with a first data bus 124 or by other means.

The private packet network may also be coupled to a public packet network such as the Internet 108. Preferably, a firewall 112 or other security measures are used to protect devices on the private packet network 106. A customer computer 52, such as a personal computer or hand-held personal digital assistant (PDA) may be coupled to the Internet through any number of networks, switches, and routers. The customer computer 52 includes a second processor 202 for executing machine language instructions stored at a second data storage 204. A user input 206, such as a keyboard and mouse, and user output 208, such as a display screen, provide means for a customer to interact with the customer computer 52 and thus, with the exemplary system.

Thus, during operation, the customer may provide information on customer traits and request information on representatives and may select a sales representative through the customer computer 52 located at a customer premises. However, in a further embodiment, communication between the customer and the server may be through another media, such as oral communication or hand-written communication. In this embodiment, an input terminal 114 is coupled with the private packet network 106 and communicates with a customer premises computer 116 over a non-packet media channel 122. The non-packet media channel 122 may take various forms, such as a telephone line, in-person communications, a messaging service, or a survey form being completed by the customer, for instance. Once information is received from the customer premises 116 at the input terminal 114, the information is entered into the system through the input terminal. Typically, the information will be stored in the first data storage 104. Although the input terminal 114 is shown coupled to the server 50 through the private packet network 106, other configurations are available. For instance, the input terminal 114 may be more closely associated with the server 50.

Representative information, such as representative traits are provided through a representative interface 304. The representative interface may be coupled to the private packet network 106 or to the internet 108 (as shown by the dashed line). Each representative may be given the facility to update their own traits. Alternatively, the traits may be modified and updated by the vendor.

The representative interface 304 may also be used to provide communication to the representative. For instance, the representative interface 304 may provide a notice to the representative that the customer has been matched with the representative.

Of course, other embodiments, combinations and modifications of this architecture will occur readily to those of ordinary skill in the art in view of these teachings and in view of the following descriptions of exemplary operations.

3. Exemplary Messaging

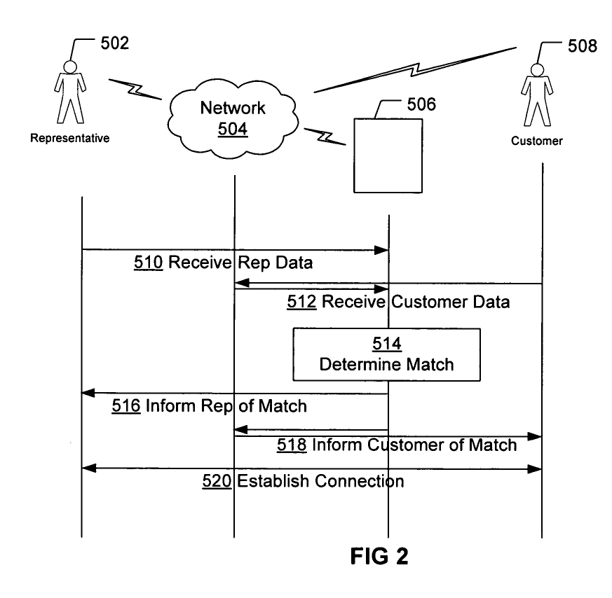

FIG. 2 is a messaging diagram showing an exemplary operation of a method of allocating a sales representative 502 to a customer 508 based, at least in part, on customer input. The exemplary operation is configured to generate a customer-representative match and then inform the customer 508 and representative 502 of the match. In alternative embodiments, a matching algorithm a server 506 may provide any number of results to either the customer 508 and/or representative 502 for approval or selection.

In FIG. 2, a network 504, such as a packet switched network, is communicatively coupled with a server 506. Likewise, the sales representative 502 and customer 508 are communicatively coupled through the network 504.

At step 510, the server 506 receives representative data that is indicative of match-relevant traits of the representative 502. The representative data is stored in data storage at the server 506 or at another location communicatively coupled with the server 506. At step 512, the server 506 receives customer data that is indicative of match-relevant traits of the customer 508. The customer data is likewise stored in data storage at the server 506. At step 514, the server 506 determines a customer-representative match based on the received customer data and representative data.

At steps 516 and 518, the server sends messages to the representative 502 and customer 508 respectively. The messages are indicative of the customer-representative match and may include match criteria and other information regarding the customer 508 and/or representative 502. The message sent to the representative 502 at step 516 may be different from the message sent to the customer 508 at step 518. The message may be sent via an electronic message, web page, telephone, or via paper, for instance.

Once the customer 508 and/or representative 502 have been notified of the match, a connection may be established between the two. Establishing the connection take various forms such as: (i) creating a new contact by storing trait information in a database accessible to the customer 508 and/or representative 502; (ii) having a telephone conversation, such as a VoIP conversation initiated through a browser interface or through another telephone connection; (iii) communicating electronically such as through an e-mail or instant message; or (iv) communicating via mail, for instance.

4. Exemplary Operational Flow

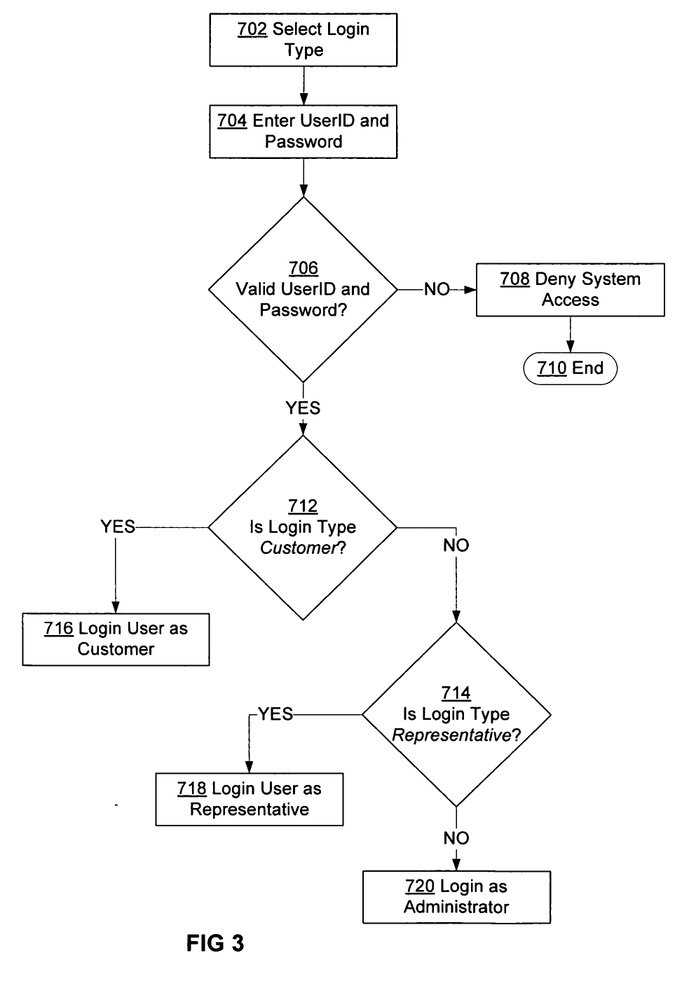

FIGS. 3 through 8 are operational flow charts and may provide a better understanding of various aspects of operation in an exemplary embodiment.

a) Login Procedure

FIG. 3 is an operational flow chart showing of an exemplary user login procedure. The procedure is configured to operate with users of various login types. For instance, in the embodiment, the login type may be any of a customer, a representative, or administrator. Functional steps, both within and after the login procedure, may be affected depending upon the login type of the user. For instance, an administrator may be provided with access to different functions than would a customer. During the login sequence a user may interact with a network server directly or through a packet network.

At steps 702 and 704, the user selects a login type and enters a UserID and Password to login to the system. Although in the exemplary embodiment, login types are restricted to customer, representative and administrator, other login types may be used as well. For instance, the customers may be divided into current customers and prospective customers. Additionally, there may be various types of administrators. Further, an additional login type may be needed for vendor affiliates. More generally, at step 702, a login type user-query may be formatted to require the user to select a login type from a list of a plurality of login types provided.

Depending upon needs of the system, various levels of access restriction security may be provided by the system. In some cases, users may be allowed to access the system without providing any UserID or Password. In a further example, the system may allow a user to login after providing a valid e-mail address or other contact information. In the exemplary embodiment, at step 706, the system determines whether the UserID and Password are valid. If the UserID and Password are not valid, then the user is denied access to the system 708 and the communications session completed at 710. Although not shown in FIG. 3, the system may give a user a number of opportunities to enter a valid UserID and password.

Once the UserID and Password are validated, the system determines the user login type based on the login type selection made by the user. At step 712, the system determines if the login type is ‘customer.’ If the login type is ‘customer’ then, at step 716, the user is logged in as a customer. If the login type is not ‘customer,’ then, at step 714, the system determines if the login type is ‘representative.’ If the login type is ‘representative’ then, at step 718, the user is logged in as a representative or sales rep. As a default, at step 720, the user may be logged in as an administrator.

Other login procedures are available. For instance, a login database may associate the UserID with a particular login type. Thus, once the UserID and password are validated, the system may login the user as that particular login type without additional input from the user.

b) Customer Flow

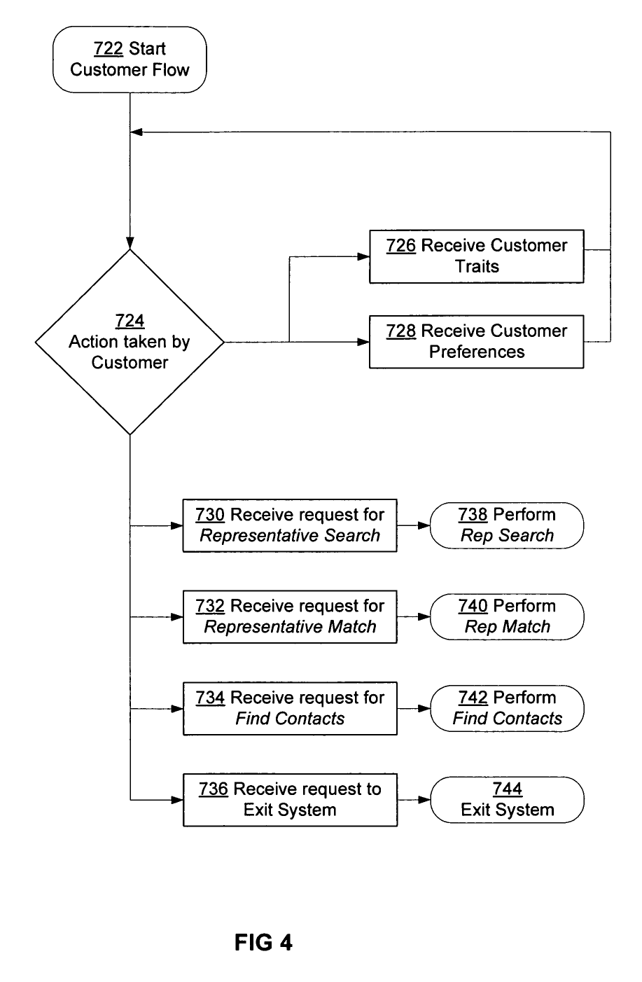

Once a customer is logged into the system, the customer may have a number of options available. An exemplary set of options are shown in FIG. 4. FIG. 4 is an operational flow chart showing of an exemplary customer flow. At step 722, the customer flow starts. At step 724, the customer chooses an action and submits an action request to the system. According to the exemplary embodiment, the customer may select an action through a graphical user interface at a customer premises computer. The enumerated actions may be chosen in any order.

At step 726, the customer has chosen to view or edit customer traits and any new or edited customer traits may be received into the system. The customer traits may be broken into a number of categories, such as (i) demographic information that may include customer name and contact information; (ii) relationship type that may indicate the type of relationship that the customer would prefer to have with the vendor. In the embodiment, the relationship type may be (a) tactical in that the customer's intentions are in buying a single product from the vendor with minimal future contact; (b) standard, in that the customer is looking to the vendor to solve a current problem, but may need further assistance in the future; or (c) rich, in that the customer is looking to work closely with the vendor over an extended period of time, for instance. The customer traits may also include (iii) buying process information. As an example, the buying process information may indicate (a) whether a product selection has already been made; (b) who is responsible for making a product selection; (c) whether a product proposal is requested; (d) whether market research is needed; and/or (e) a purchasing timeframe. The customer traits may further include (iv) personal and (v) professional information as well as (vi) customer network information, for instance. As an example, the customer network may include information regarding the customer's stored contacts. Further, the customer network information may include instructions or parameters for obtaining the customer's traits by accessing demographic data through an online social networking space. Preferably, the customer is able to view and change the customer traits at step 726 through the customer premises computer that accesses the data and functions via a packet network.

At step 728, the customer has chosen to view or edit customer preferences and any new or edited customer preferences may be received into the system. The customer preferences may be broken into a number of categories such as (i) frequency of contact that may indicate how often a customer would prefer to be contacted by a sales representative; and (ii) network preferences, for instance.

Once the customer traits and preferences have been viewed and/or edited, the customer flow may return to step 724, thus allowing the customer to take another action within the system.

In addition to viewing and updating the customer traits and preferences, the customer may also initiate a search or match to find a representative. Various searching and matching options may be provided by the various embodiments. In the exemplary embodiment, three search/match algorithms are provided: (i) a representative search; (ii) a representative match; and (iii) a find contacts search. The customer may initiate these search/match functions as follows: At step 730, the system receives a request from the customer to initiate a ‘representative search.’ In response to the request, the system initiates a representative search at step 738. At step 732, the system receives a request from the customer to initiate a ‘representative match.’ In response to the request, the system initiates a representative match at step 740. At step 734, the system receives a request from the customer to initiate a ‘find contacts’ search. In response to the request, the system initiates a find contacts search at step 742. Although there is synergistic value for providing functionality for at least all three search/match functions in a single application, other embodiments may provide for implementation of less than all of the functions.

At step 736, the system receives a request from the customer to exit the system or logout. In response to the request, the user is exited from the system at step 744.

c) Representative Search

One of the search/match functions provided in the exemplary embodiment is a representative search. The representative search allows for the customer to provide a list of desired traits and receive a ranked list of vendor representatives who match the desired traits.

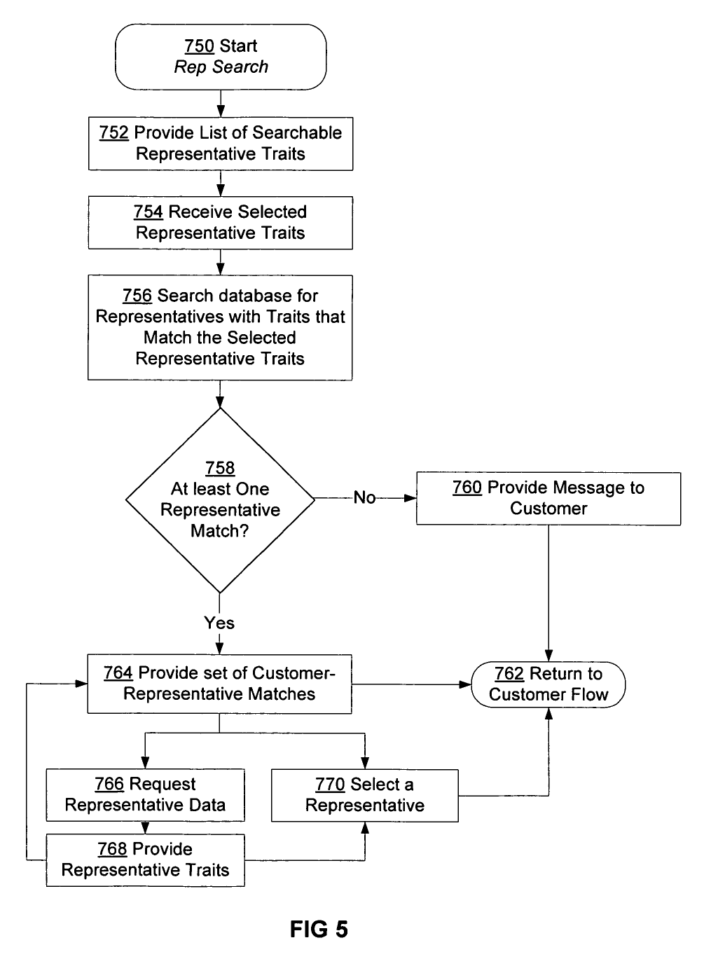

FIG. 5 is an operational flow chart showing an exemplary representative search function. At step 750, the representative search starts. At step 752, the system provides a structure of searchable representative traits to the customer. The structure may be provided as a series of drop-down boxes in a graphic user interface (GUI), for instance. Alternatively, the structure may be provided as a set of labeled check-boxes in a GUI. The GUI may then query the customer as to a desired value for each check-box selected by the customer. Once the customer has entered or selected values for the selected representative traits, those values are delivered to the system at step 754.

At step 756, a representative database at a network server is searched for representatives with traits that match the selected representative traits. According to an exemplary embodiment, the searching may allow for partial matches. For example, entering a city of “Palo” may match with representatives whose city trait is set to “Palo Alto”, “Palomar” or any other city that begins with “Palo.” Other searching mechanisms may be used. For instance, a negative trait may be provided to exclude or downgrade a match probability (via match score) of a representative having that trait.

At step 758, the system determines whether at least one representative matches the selected representative traits. Depending upon system and customer preferences, a match may be (i) restricted to cases where every criteria is matched or (ii) allow for the case where only a subset of selected representative traits are matched.

At step 760, if no match is found then a message is provided to the customer indicating that the search had failed to reap any matching representatives. The customer may then, at step 762 be redirected to the customer flow (FIG. 4) or to another re-entry point.

At step 764, if at least one match was found then a set of customer-representative matches are provided to the customer. The set of customer-representative matches may include a list of all representatives found who match traits entered by the customer and may also include summary information about the representatives and an indication as to the matching traits.

Once the customer receives the set of customer-representative matches, the customer may request further data about any of the particular representatives in the set at step 766. In response to the request for representative data, the customer is provided with a set of representative traits for the particular representative at step 768. The customer may then select the representative as the preferred representative at step 770 or return to the set of customer-representative matches at step 764.

As partially shown by arrows to step 762, in the exemplary embodiment, the customer may return to the customer flow (FIG. 4) at any point during the representative search.

d) Representative Match

Another search/match functions provided in the exemplary embodiment is a representative match. The representative match operates by generating a set of customer-representative matches by comparing traits of the customer with similar or complementary traits of available representatives. According to an embodiment, the representative match function is performed by calculating a match score for each of a plurality of available representatives. Although the calculation may be mathematically inverted without materially altering the outcome, in the currently described embodiments a greater match score is indicative of a better customer-representative match.

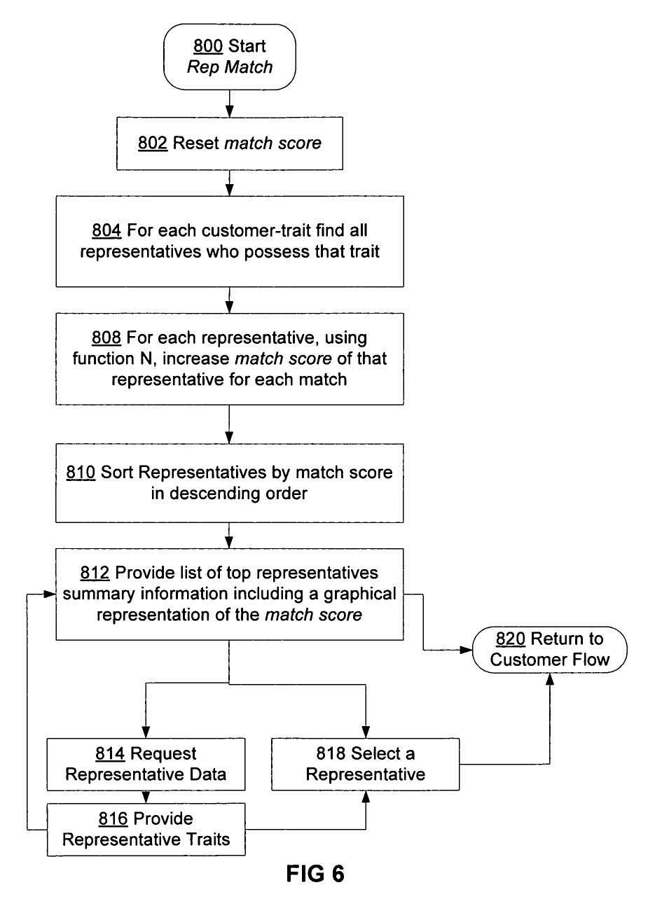

FIG. 6 is an operational flow chart showing exemplary representative match functionality. A function N is configured as a quantitative determinant of the matching procedure. Generally, each customer-representative match will be given a numeric value for N that indicates a match quality. The match quality may be defined to represent (i) an expected likelihood that a strong relationship will develop between the customer and the given representative or (ii) an expected strength of a relationship between the customer and the given representative, for instance.

At step 800, the representative match starts. At step 802, the match score for each representative is set to zero. At step 804, each customer-trait and representative-trait is retrieved from data storage and examined. Specifically, for each customer-trait, all representatives are found who possess that trait.

As step 808, the match score N for each customer-representative match is increased by a numeric value for each trait that the respective representative shares with the customer. In the exemplary embodiment the value for N, when associated with a particular customer-representative match is an integer that directly reflects the number of traits shared by the customer and representative. Thus, in the embodiment, the value for N may be increased by one (1) for each matching trait. In another embodiment, N is calculated based on a weighted value of a match for a particular trait. For instance, a customer-representative trait match of “undergraduate university” may receive a higher N-value than that of “marital status.” The function for N may be set as a customer-preference and/or by the system. In yet another embodiment, the function N depends on a number of factors including (i) the weight each trait match is given by the customer; (ii) the weight each trait match is given by the vendor and/or representative; (iii) weights given to partial matches versus full matches; and (iv) a scalar addition. Further, any combination of these factors may be used as well as other factors.

The comparison of traits may further be divided into functional groups of traits. For instance, the system may first determine trait-matches based on demographic information, then based on personal information, and followed with professional information. Further, each functional group may be associated with a different N-value. Thus, matches in the demographic information group may be valued at a greater level than matches in the professional information group or vice-versa, for instance.

At step 810, the representatives with positive match scores may be culled according to a cutoff value and sorted in descending order according to the match score. At step 812, the list of representative and accompanying summary information are provided to the customer. An indication for a graphical representation of each match score may also be provided.

Once the customer receives the set of customer-representative matches, the customer may request further data about any of the particular representatives in the set at step 814. In response to the request for representative data, the customer is provided with a set of representative traits for the particular representative at step 816. The customer may then select the representative as the preferred representative at step 818 or return to the set of customer-representative matches at step 820.

As partially shown by arrows to step 820, in the exemplary embodiment, the customer may return to the customer flow (FIG. 4) at any point during the representative search.

Once a representative is selected at step 818, the representative may be associated with the customer as the customer's sales representative. At that point, both the customer and representative may be provided with contact information for the other party in order to facility the creation of a fruitful relationship.

e) Find Contacts

Another search/match function provided in the exemplary embodiment is a find contacts search. A customer may user the find contacts function when the customer believes that there are already representatives at the vendor who are associated with the customer's network or contact list. According to an embodiment, the find contacts function operates by comparing a customer's network with a plurality of representative listings available on a system database.

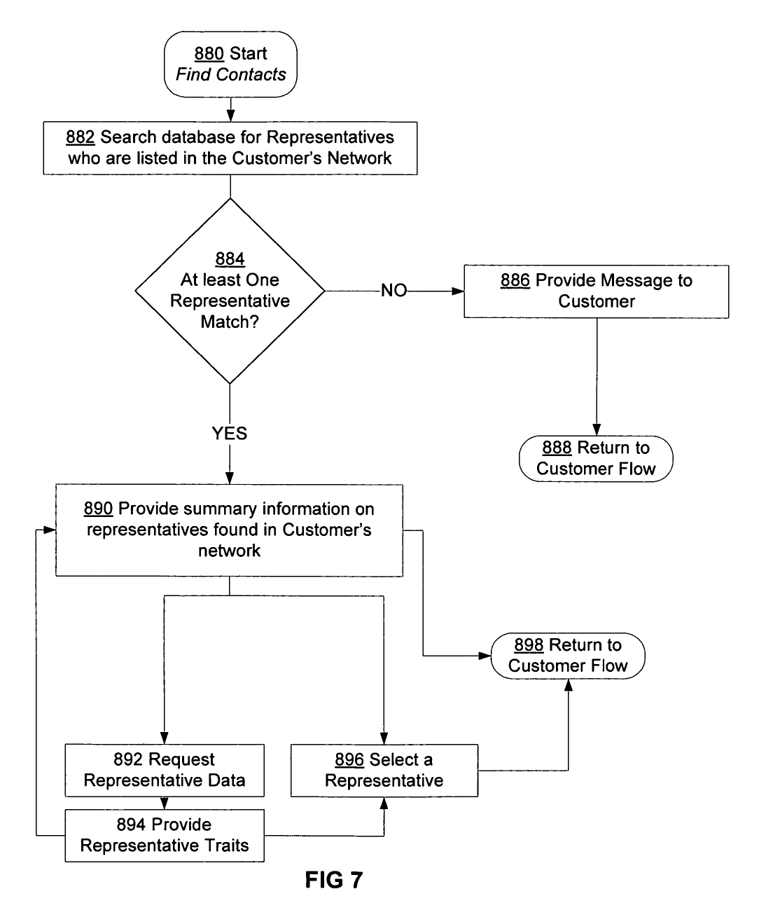

FIG. 7 is an operational flow chart showing an exemplary find contacts function. At step 880, the find contacts function starts. At step 882, the system database is searched for representatives who are listed in the customer's network. The customer's network may be available for searching through a variety of means. For instance, (i) the customer's network may be uploaded or forwarded to the system database and stored therein; (ii) the customer's network may be scanned at the customer premises computer; or (iii) the customer's network may be available through an on-line social networking system.

At step 884, the system determines whether at least one of the vendor representatives is found that is listed in the Customer's network. At step 886, if no match is found then a message is provided to the customer indicating that the search had failed to reap any matching representatives. The customer may then, at step 888 be redirected to the customer flow (FIG. 4) or to another re-entry point.

At step 890, if at least one match was found then a set of customer-representative matches are provided to the customer. The set of customer-representative matches may include a list of all representatives found who are listed in the customer's network and may also include summary information about the representatives and an indication as to any matching traits.

Once the customer receives the set of customer-representative matches, the customer may request further data about any of the particular representatives in the set at step 892. In response to the request for representative data, the customer is provided with a set of representative traits for the particular representative at step 894. The customer may then select the representative as the preferred representative at step 896 or return to the set of customer-representative matches at step 890.

As partially shown by arrows to step 898, in the exemplary embodiment, the customer may return to the customer flow (FIG. 4) at any point during the representative search.

In a further embodiment, the find contacts function finds representatives that are within M-degrees from the customer in a social network. For instance, using 1-degree of separation, the find contacts function may locate all representatives who are either (i) in the customer's network or (ii) in the network of a third party who is himself in the customer's network. The M-degrees provide, in essence, a recommendation for particular representatives. As an example, an on-line social network such as Orkut, Friendster, or Tribe.net may be configured to provide degree information. Alternatively, traits stored in a vendor file that are associated with the customer may be used.

Alternatively or additionally, the system may be configured to allow the customer to search background information regarding the representatives. For instance, in an embodiment the customer may search the representatives background for endorsement or testimonial information from other customers.

f) Representative Flow

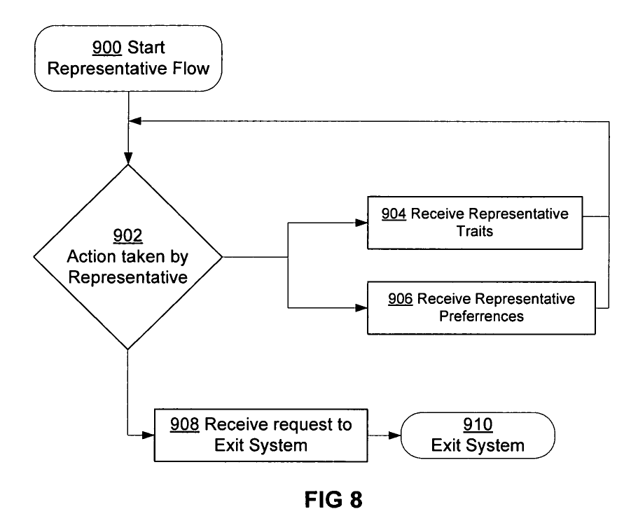

A representative may log into the system to change both traits and preferences of the representative. For instance, if the representative moves from one location to another, the representative may need to alter the representative traits regarding home city. FIG. 8 is an operational flow chart showing an exemplary representative flow that allows a representative to make these changes.

At step 900, the representative flow starts. At step 902, the representative chooses an action. The enumerated actions may be chosen in any order.

At step 904, the representative has chosen to view or edit representative traits and any new or edited representative traits may be received into the system. The representative traits may be broken into a number of categories, such as (i) demographic; (ii) preferred relationship type; (iii) personal and (iv) professional information as well as (v) representative preferences, for instance. At step 906, the representative has chosen to view or edit representative preferences and any new or edited representative preferences may be received into the system. The customer preferences may be broken into a number of categories such as (i) preferred contact preferences; and (ii) network preferences, for instance.

Once the representative traits and preferences have been viewed and/or edited, the representative flow may return to step 902, thus allowing the representative to take another action within the system. At step 908, the system receives a request from the representative to exit the system or logout. In response to the request, the user is exited from the system at step 910.

5. Offline Usage

a) Overview

For any number of reasons, in many cases customers may not initiate contact with the vendor through an on-line resource in order to find a representative. For instance, in the pharmaceutical industry, either through lack of time or motivation, it would be unlikely for a physician to search for a drug-representative that matched well with his traits.

In order to accommodate off-line use of the representative match, the vendor may contact the customer through a medium such as by telephone, in person, or through the mail in order to obtain information on customer traits.

Further customer information may be obtained through other sources as well, such as a credit check or personal investigation. Thus, in some cases, the customer may not be aware that certain customer trait information is being obtained. However, in an embodiment, it may be desirable to grant the customer a sense of having significant voice in the sales representative decision. Thus, in that embodiment, the system allows customers to explicitly specify customer traits and relationship preferences of the vendor.

The customer may provide various types of information that may be used by the matching system. For instance, the customer may provide any combination of: (1) their own customer traits directly, such as in the form of demographic data; (2) information regarding their own customer traits from an indirect source such as a survey; (3) desired traits of the potential sales representative; and (4) information regarding desired traits of the potential sales representative from an indirect source such as a survey.

The provided information may then be returned to a vendor location and stored in a customer data storage such as a database on a server. Using the stored customer data as well as stored representative data, a representative match function may be performed and one or more customer-representative matches identified. Once a match is identified, the customer may be notified to determine whether the customer would like to (i) accept the customer-representative match or (ii) request another customer-representative match. In a further embodiment, the customer may be provided with a print-out of a list of best-matches ranked in order of match-score, and including representative trait information for each listed representative. The customer may then select one representative (or more) as the customer's sales representative. The sales representative may then be notified of the selection. In another embodiment, a representative is assigned to the customer and the customer is then surveyed to determine whether the customer is pleased with the assignment. In yet another embodiment, a customer satisfaction or customer responsiveness rate is determined without requesting a direct response from the customer. If the customer satisfaction/responsiveness is low, then another representative may be assigned to the customer. In a further embodiment, the responsiveness rate may correlate with an order rate.

b) Extended Matching

In some cases, it may take months or years to compile customer trait information. Additionally, customer trait information may be always evolving. For instance, a drug-representative may visit a medical doctor's office once each month over the course of a year. At each visit, the drug representative may learn of a few customer traits, such as the doctor's background, schools, interests, and so forth. The drug representative may record these customer traits in a profile of the doctor in data storage. Over time, however, a sales manager may determine that the doctor is not prescribing many of the drugs offered by the drug representative. According to an exemplary embodiment, in this situation, the sales manager may perform a new representative match for the doctor and discover (i) that the current drug representative is not a proper match for the particular doctor and (ii) that another drug-representative is a better match. Further, if no excellent matches are found, the sales manager may forward a hiring request with specific representative traits to a hiring department.

Thus, in this embodiment, the customer (doctor) may never explicitly provide traits for the purpose of obtaining a representative match and, in addition, may never interact with the vendor's web-based customer-representative matching software. Yet, the vendor is able to receive from the customer a set of traits and use that information to determine a better customer-representative match.

6. Conclusions

The present invention has been described with respect to particular embodiments. Numerous modifications can be made which are within the invention, the scope of which is set forth in the following claims.

1. In a computer system, a method for associating a vendor sales representative with a customer comprising:
receiving from the customer a set of customer traits, including a set of demographic traits of the customer other than a geographic trait;
querying a database to select a set of representatives with representative traits that match the set of traits received from the customer;
providing the customer with indicia of the set of representatives; and
receiving from the customer a representative selection, wherein the representative selection is indicative of at least one of the representatives of the set of representatives.

2. The method of claim 1, further comprising adding the at least one of the representatives to the customer's network.

3. The method of claim 1, wherein the vendor sales representative is a pharmaceutical company's sales representative and the customer is a medical doctor who may prescribe medicine associated with the pharmaceutical company.

4. The method of claim 1, wherein communication with the customer occurs through a packet network.

5. The method of claim 1, wherein the set of representatives is only one representative.

6. The method of claim 1, further comprising ordering the set of representatives according to a match quality.

7. The method of claim 1, wherein all information exchange between the computer system and the customer occur through mediums selected from: personal meeting with a vendor representative; telephone conversation with the vendor representative; post; and fax.

8. The method of claim 1, wherein querying a database to select the set of representatives comprises:
for each trait of the customer, finding all representatives who (i) match or (ii) partially match that trait; and
for each representative, increase a match score of that representative using the function N for each match.

9. The method of claim 8, wherein N is a numeric variable and operates as a function of weighted customer and representative traits.

10. The method of claim 8, wherein N is a numeric variable and operates as a function of functional groups of traits.

11. The method of claim 8, further comprising:
sorting the representatives by match score in descending order.

12. The method of claim 8, wherein providing the customer with indicia of the set of representatives includes providing (i) a list of matching representatives; (ii) summary information concerning each matching representative; and (iii) an indicia for providing a graphical representation of the match score.

13. A method for associating a vendor sales representative with a customer comprising:
receiving an action request from the customer;
if the action request is a representative search request, performing a representative search function, wherein the representative search function includes providing the customer with a first set of customer-representative matches, and wherein each match of the first set of customer-representative matches exhibits representative traits that correspond to selected traits submitted by the customer; and
if the action request is a representative match request, performing a representative match function, wherein the representative match function includes providing the customer with a second set of customer-representative matches, and wherein each match of the second set of customer-representative matches exhibits representative traits that correspond with traits of the customer.

14. The method for associating a vendor sales representative with a customer of claim 13, further comprising:
if the action request is a find contact request, performing a find contact function, wherein the find contact function includes providing the customer with a third set of customer-representative matches, and wherein each match of the third set of customer-representative matches was previously associated with the customer's network.

15. The method for associating a vendor sales representative with a customer of claim 14, wherein being associated with the customer's network includes being associated with a 1-degree separation.

16. The method for associating a vendor sales representative with a customer of claim 13, further comprising:
receiving from the customer a representative selection, indicative of at least one match provided to the customer.

17. A system for associating a vendor representative with a customer comprising:
a distributed network including a server, data storage, and a remote terminal communicatively inter-coupled;
a vendor representative database stored in data storage, wherein the vendor representative database is configured to store representative traits of vendor representatives;
program logic stored in data storage and executable by a processor on the server for (i) receiving a set of customer traits of the customer; (ii) comparing the set of customer traits with the stored representative traits; (iii) ranking customer-representative matching based on the comparison; and (iv) providing a ranked listed of representatives to the customer, accessible at the remote terminal, whereby the customer may provide input as to which representative is assigned to the customer.

18. The system of claim 17, wherein at least a portion of the set of customer traits are received from any of (i) an online social network; or (ii) traits stored in a vendor file associated with the customer.

19. The system of claim 17, further comprising a network interface for communicating with a customer premises computer across a packet network.

20. The system of claim 17, wherein the program logic further provides for (v) performing a representative search function; and (vi) performing a contact find function.

21. A method for selecting a vendor sales representative for a customer comprising:
obtaining a set of customer traits, wherein at least a portion of the customer traits are obtained through an off-line source;
storing the set of customer traits in a data storage;
in response to a trigger, matching a given sales representative with the customer based on the set of stored customer traits; and
providing the customer an indicia of the given sales representative.

22. The method of claim 21, wherein the indicia is a print-out list including a set of best-matched sales representatives ranked according to a match score.

23. The method of claim 21, further comprising periodically determining whether a new vendor sales representative should be selected for the customer.

24. The method of claim 21, wherein at least a portion of the set of customer traits are obtained by a current sales representative.

25. The method of claim 21, wherein the offline sources include any of (1) direct customer statements concerning customer trait information; (2) indirect customer statements concerning customer trait information; (3) direct customer statements concerning desired traits concerning a potential sales representative; or (4) indirect customer statements concerning the potential sales representative.

22. The method of claim 21, wherein the customer is not made aware that customer trait information is being obtained.

24. The method of claim 21, further comprising
Providing the customer with an indication that the customer's input is a significant factor in the determination of the sales representative.

25. The method of claim 21, wherein the customer traits include non-demographic customer traits.
